(19) United States
(12) Patent Application Publication
(10) Pub. No.: US 2006/0259348 A1
(43) Pub. Date: Nov. 16, 2006

(54) System and Methods of Calculating Growth of Subscribers and Income From Subscribers

(75) Inventor: Jeffrey R. Horowitz, Sherman Oaks, CA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Youbet.com, Inc., Woodland Hills, CA (US)

(21) Appl. No.: 11/277,100

(22) Filed: Mar. 21, 2006

Related U.S. Application Data
(60) Provisional application No. 60/679,598, filed on May 10, 2005.

(51) Int. Cl. G07G 1/00

(52) U.S. Cl. 705/10

(57) ABSTRACT

The subject invention provides a first method for estimating the number of subscribers to a service. The first method calculates the number of subscribers based on a rate of additional subscribers and a rate of departing subscribers, where the rate of departing subscribers is recursively depending on the number of subscribers. The subject invention also provides second and third methods for estimating an amount of income attributable to the subscribers of the service. The second method assigns different contributions to the total income based on the additional subscribers and departing subscribers. The third method segments the number of subscribers into subscriber groups, then assigns different contributions tot the total income based on each subscriber group. A computer based system is also disclosed for performing the methods.

### CROSS REFERENCE TO RELATED APPLICATION

This application claims the benefit of provisional application Ser. No. 60/679,598 filed May 10, 2005, which is hereby incorporated by reference.

### FIELD OF THE INVENTION

The subject invention provides methods for estimating a population of subscribers and the income generated by the subscribers. More specifically, the subject invention provides methods for estimating the number of subscribers to an online gaming service for pari-mutuel wagering on races and for estimating the growth of the handle of wagers.

### BACKGROUND OF THE INVENTION

Methods relating to customers (or subscribers) to a service (or system) are known by those skilled in the art. One such method is disclosed in United States Patent Application Publication No. 2002/0158771 to Shen et al. (the '771 publication).

The '771 publication is directed towards a retention methodology for airlines. Specifically, the '771 publication teaches analyzing information about customers of an airline based on a customer population, which is a function of a customer acquisition value, a customer attrition value, and an initial customer population. The customers are also evaluated to determine a customer value. The customer value is a function of a time period in which the customer uses the airline, a frequency in which the customer uses the airline, and a profit the airline makes from the customer.

Although the '771 publication discloses methods for determining a value of a customer, it does not disclose methods for estimating a growth in a number of subscribers to a service nor does it disclose methods for estimating an amount of income, e.g., wagers, attributable to those subscribers.

The subject invention is aimed at one or more of the problems set forth above.

### SUMMARY OF THE INVENTION AND ADVANTAGES

A first aspect of the subject invention provides a method of estimating a number of subscribers to a service at a time period. The method includes the step of calculating a cumulative number of additions to the number of subscribers at the time period based on a rate of additional subscribers. A cumulative number of departures to the number of subscribers at the time period is calculated based on a rate of departing subscribers. The rate of departing subscribers is a function of the number of subscribers at a preceding time period. The method also includes the step of calculating the number of subscribers at the time period based on an initial number of subscribers, the cumulative number of additions, and the cumulative number of departures.

A second aspect of the subject invention provides a method of estimating an income provided by subscribers to a service at a time period. The method includes the steps of establishing a rate of additional subscribers added during each time period and establishing a rate of departing subscribers departing during each time period. A preceding number of subscribers at a preceding time period which precedes the time period is calculated based on an initial number of subscribers, the rate of new subscribers, and the rate of departing subscribers. The method also includes the steps of establishing a first average amount of income attributable to each added subscriber and establishing a second average amount of income lost for each departed subscriber. A preceding average contribution to the income provided by each subscriber at the preceding time period is calculated based on the first amount of income, the second amount of income, the estimated rate of additions, the estimated rate of departing subscribers, and the preceding number of subscribers. The method further includes the step of calculating the income provided by subscribers at the time period based on the preceding average contribution, the preceding number of subscribers, the first amount of income, the second amount of income, the estimated rate of additions, and the estimated rate of departures.

A third aspect of the subject invention provides a method of estimating an income provided by subscribers to a service at a time period. The method includes the step of dividing the subscribers into a plurality of subscriber groups. The method further includes the steps of establishing an estimated rate of additions to a number of subscribers during each time period for each subscriber group and establishing an estimated rate of departures from the number of subscribers during each time period for each subscriber group. A number of subscribers in each subscriber group is calculated based on the estimated rate of additions and the estimated rate of departures. The method further includes the step of establishing an average amount of income attributable to each subscriber in each subscriber group. The total income provided by subscribers at the time period is calculated based on the number of subscribers in each subscriber group and the average amount of income attributable to each subscriber in each subscriber group.

A fourth aspect of the subject invention provides a computer based system for estimating a number of subscribers to a service at a time period. The system includes a memory for storing data and a processor coupled to the memory. The process calculates a cumulative number of additions to the number of subscribers at the time period based on a rate of additional subscribers. The processor also calculates a cumulative number of departures to the number of subscribers at the time period based on a rate of departing subscribers, the rate of departing subscribers being a function of a preceding number of subscribers at a preceding time period. The processor further calculates the number of subscribers at the time period based on an initial number of subscribers, the cumulative number of additions, and the cumulative number of departures.

The methods and system of the aspects of the subject invention provide various advantages over the prior art. Specifically, the first aspect of the subject invention may be utilized to estimate a future number of subscribers to the service. The second and third aspects of the subject invention may be utilized to estimate the income provided by the subscribers to the service. All of these methods provide crucial business information allowing operators of the service to make informed decisions and plan for future business growth.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a table showing a first example of a first method for estimating the number of subscribers to a service;

FIG. 2 is a table showing a second example of a second method for estimating the income provided by subscribers to the service;

FIG. 3 is a table showing the income provided by a first segment of subscribers to the service estimated by a third example of a third method;

FIG. 4 is a table showing the income provided by a second segment of subscribers to the service estimated by the third example of the third method;

FIG. 5 is a table showing the income provided by all of the subscribers to the service estimated by the third example of the third method; and

FIG. 6 is a schematic view of a computer based system.

### DETAILED DESCRIPTION OF THE INVENTION

With reference to the figures, and in operation, the subject invention provides methods of estimating a number of subscribers to a service and estimating income provided by subscribers to a service, as well as a computer based system 10 for implementing these methods. The methods and computer based system 10 of the subject invention are particularly suited for use with an online gaming system, particularly with an emphasis on pari-mutuel gambling, such as is common with horse or greyhound racing. Therefore, the subscribers to the service may be customers and the income may be referred to as the “handle” of wages placed by the customers. Of course, those skilled in the art realize that the methods described herein may be implemented in other situations other than gaming. Furthermore, any reference to one particular application of the methods made below should be considered as exemplary and should not be read as limiting.

A first aspect of the invention provides a first method for estimating a number of subscribers to a service. To best understand the first method, a review of the mathematical underpinnings of the first aspect, as presented below, is helpful.

First, let n(t) be a function that represents the number of subscribers over a time variable t. The number of subscribers, n(t), may alternatively be described as a population of subscriber or a subscriber population. Next, let a(t) be a function that represents additional subscribers, i.e., subscriber acquisitions, over the time variable t. Let s(t) be a function that represents departing subscribers, i.e., subscriber attrition, over the time variable t. Furthermore, let No denote an initial number of subscribers (or an initial population) at an initial time, where t=0.

The number of subscribers, n(t), at time t is the initial number of subscribers N₀ plus the difference between additional subscribers, a(t), and departing subscribers, s(t), as provided by
n(t)=N₀+α(t)−s(t)
Studies of online gaming systems show that the number of additional subscribers a(t) grows at a relatively constant rate. Mathematically, the rate of change of a function is equivalent to the first derivative of that function. In other words, a constant may be defined, say α, such that
α′(t)=da/dt=α,
where a'(t) and da/dt each represent a first derivative of s(t). Solving for s(t) provides
α′(t)=∫α(t)dt=∫αdt=αt+C₁,
where C₁ is a constant which can be defined as zero (0), since all additional subscribers at time zero (0) are factored into N₀. Therefore,
α(t)=αt.

Similarly, studies of online gaming systems show the number of departing subscribers a(t) grows at a relatively constant percentage of the number of subscribers, n(t). In other words, there is a constant, say β, such that
s′(t)=ds/dt=βn′(t−Δt).
The above equation says that the rate of departures of subscribers, s'(t), at time t is a function of the growth of the number of subscribers n(t) prior to time t. Solving for the number of departures of subscribers, s(t), provides
s(t)=∫s′(t)dt=∫βn′(t−Δt)dt=βn(t−Δt)+C₂.
Since the number of departing subscribers at time zero (0) are factored into N₀, it follows that s(0)=0. So,
s(0)=0=βn(Δt)+C₂,
and
C₂=−βn(Δt),
therefore,
s(t)=βn(t−Δt)−n(Δt).

From the above equations, the number of subscribers, n(t), can be established as
n(t)=N₀+α(t)−s(t)=N₀+αt−β(n(t−Δt)−n(Δt)).

The above equation can be cumbersome, as the number of subscribers is recursively dependent on itself. In other words, the number of the number of subscribers at time t directly depends on the number of subscribers just before time t. The first method provides an estimate of a number of subscribers, N_{T}, to the service at a time period, T.

The first method includes the step of calculating a cumulative number of additions, A_{T}, to the number of subscribers at the time period, T. The cumulative number of additions is based on a rate of additional subscribers, A_{R}. In one embodiment, calculating the cumulative number of additions, A_{T}, at the time period, T, is further defined as using the equation A_{T}=A_{T-1}+A_{R}, where A_{T-1} is the cumulative number of additions to the number of subscribers at a preceding time period, T−1. However, those skilled in the art realize that other equations or calculations may be used to calculate the cumulative number of additions, A_{T}.

The estimated rate of additions, A_{R}, may be a constant value applicable to any time period or may be variable depending on the time period or other factors. The estimated rate of additions, A_{R}, may be established according to an average rate of additions observed over a plurality of previous time periods. Said another way, historical data concerning the number of additional subscribers may be averaged to determine the estimated rate of additions.

The first method further includes the step of calculating a cumulative number of departed subscribers, S_{T}, to the number of subscribers at the time period, T, based on a rate of departing subscribers, S_{R}. The rate of departing subscribers, S_{R}, is a function of the number of subscribers, N_{T-1}, at the preceding time period, T−1. In one embodiment, the step of calculating the cumulative number of departed subscribers, S_{T}, at the time period, T, is further defined as using the equation S_{T}=S_{T-1}+S_{R}P_{T-1}, where S_{T-1} is the cumulative number of departed subscribers to the number of subscribers at the preceding time period, T−1, and P_{T-1} is the number of subscribers at the preceding time period, T−1. In one embodiment, S_{R} is expressed as a percentage of the number of subscribers, P_{T-1}.

As with the estimated rate of additions, A_{R}, the estimated rate of departed subscribers, S_{R}, may be a constant value applicable to any time period or may be variable depending on the time period or other factors. The estimated rate of departed subscribers, S_{R}, also may be established according to an average rate of departures observed over a plurality of previous time periods.

The first method also includes the step of calculating the number of subscribers, N_{T}, at the time period, T, based on an initial number of subscribers, N₀, the cumulative number of additions, A_{T}, and the cumulative number of departing subscribers, S_{T}. Specifically the number of subscribers, N_{T}, is calculated with the equation N_{T}=N₀+A_{T}−S_{T}. The equation can be simplified if N₀ is set to 0, reflecting performing the first method starting at a time period where there are no subscribers, resulting in the equation N_{T}=A_{T}−S_{T}. By combining equations, the number of subscribers may be calculated using the equation N_{T}=A_{T-1}+A_{R}−(S_{T--1}+(S_{T-1})(S_{R})), provided that the rate of additions, A_{R}, is expressed as a constant number during each time period and the rate of departures, S_{R}, is expressed as a percentage of the number of subscribers, P_{T-1}.

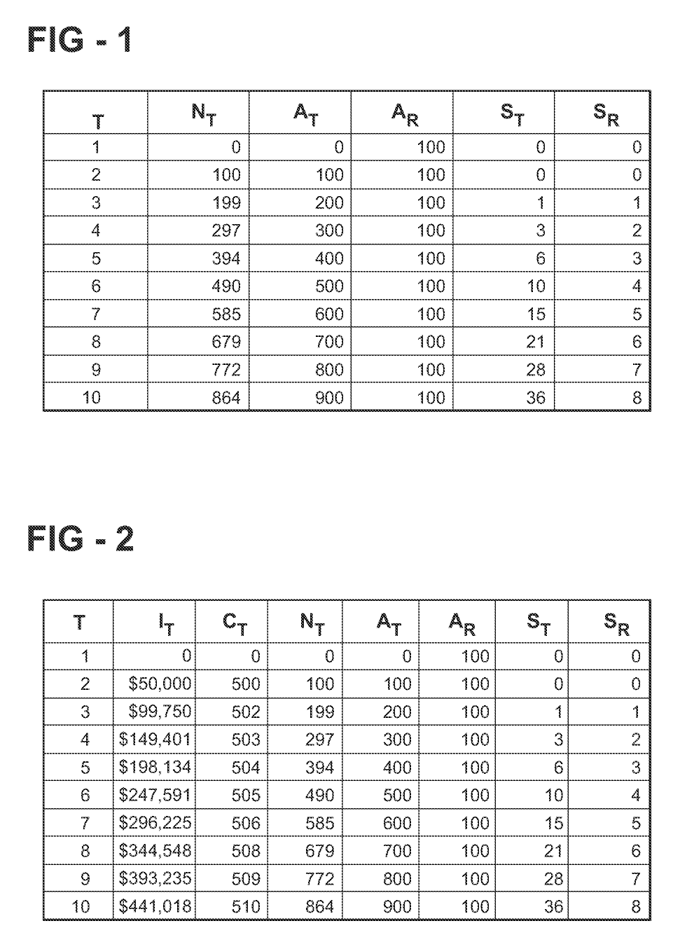

A first example showing performance of the first method can be seen in FIG. 1. In this first example, the rate of additions, A_{R}, is 100 new subscribers per time period and the rate of departures, S_{R}, is 1% of the number of subscribers. The first example also assumes that the number of subscribers, N_{T}, the cumulative number of additions, A_{T}, and the cumulative number of departures, S_{T}, before the first time period (T=1) are all zero.

The first method may also include the step of substituting a special number of additions, A_{S}, for the constant rate of additions, A_{R}, when calculating the cumulative number of additions, A_{T}. This substitution may be implemented during one or more time periods. This substitution is particularly advantageous when the method is used to determine the number of subscribers to the online gaming system, because annual high-profile horse racing events, such as the Kentucky Derby, often spur a high number of new subscribers in one or more time periods immediately preceding the high-profile event. This high number of new subscribers is typically substantially greater than the constant rate of additions, A_{R}, found during time periods not immediately preceding the high-profile event.

A second aspect of the invention provides a second method for estimating an income provided by subscribers to the service. This second aspect of estimating income builds on the estimation of the number of subscribers of the first aspect. Again, to best understand the second method, a review of the mathematical underpinnings, as presented below, is helpful.

First, let i(t) be a function that represents the income expected from the subscribers at time t and c(t) be a function that represents the average contribution to the income by each subscriber at time t, and, as before, let n(t) be a function that represents the number of subscribers, a(t) be a function denoting new subscribers, and s(t) be a function denoting departing subscribers.

An equation for the income provided by subscribers i(t) can be developed as follows:
i(t)=c(t−Δt)n(t−Δt)+I_{A}α′(t)−I_{S}S′(t),
where I_{A} represents an average contribution to the income provided by additional subscribers over time and I_{S} represents an average contribution to the income provided by departing subscribers over time. In other words, the income at time t is the income generated by existing subscribers plus the income generated by additional subscribers, less the income lost by departing subscribers. By assuming I_{A} and I_{S} are not equal, then i(t) will vary over time.

The second method provides estimation of income, I_{T}, provided by subscribers to the service at the time period, T. The second method includes the steps of establishing a rate of additional subscribers, A_{R}, added during each time period and establishing a rate of departing subscribers, S_{R}, departing during each time period. As described in the first method, the rates of additional and departing subscribers, A_{R}, S_{R}, may be constants, may be an average number found using historical data, may be the same amount during each time period, may be a function of the number of subscribers, and/or any combination thereof. Furthermore, those skilled in the art realize other techniques to establish the rate of additional subscribers, A_{R}, and the rate of departing subscribers S_{R}, may be utilized without departing from the spirit of the invention.

The second method also includes the step of calculating a preceding number of subscribers, N_{T-1}, at a preceding time period, T−1. The preceding time period, T−1, immediately precedes the time period, T. The preceding number of subscribers, N_{T-1}, is based on the initial number of subscribers, N₀, the rate of new subscribers, A_{R}, and the rate of departing subscribers, S_{R}.

The second method further includes the steps of establishing a first average amount of income, I_{A}, attributable to each added subscriber and establishing a second average amount of income, I_{S}, lost for each departing subscriber. These average amounts of income, I_{A}, I_{S}, may be determined by examining historical data concerning the amount of income provided by each subscriber, e.g., the amount wagered by each subscriber in the online gaming system.

The second method continues with the step of calculating a preceding average contribution, C_{T-1}, to the income provided by each subscriber at the preceding time period, T−1. The preceding average contribution, C_{T-1}, is based on the first amount of income, I_{A}, the second amount of income, I_{S}, the estimated rate of additions, A_{R}, the estimated rate of departing subscribers, S_{R}, and the preceding number of subscribers, N_{T-1}. In one embodiment, the preceding average contribution, C_{T-1}, may be calculated using the equation C_{T-1}=(I_{A}A_{T-1}−I_{S}S_{T-1})/N_{T-1}, where A_{T-1} is the cumulative number of additions to the number of subscribers at the preceding time period, T−1, based on the estimated rate of additions, A_{R}, and where S_{T-1} is the cumulative number of departures to the number of subscribers at the preceding time period, T−1, based on the estimated rate of departures, S_{R}.

The second method further includes the step of calculating the income, I_{T}, provided by subscribers at the time period, T. This calculation of the income, I_{T}, is based on the preceding average contribution, C_{T-1}, the preceding number of subscribers, N_{T-1}, the first amount of income, I_{A}, the second amount of income, I_{S}, the estimated rate of additions, A_{R}, and the estimated rate of departed subscribers, S_{R}. In one embodiment, the income, I_{T}, may be calculated using the equation I_{T}=C_{T-1}N_{T-1}+I_{A}A_{R}−I_{S}S_{R}.

A third aspect of the invention provides a third method for estimating the income provided by subscribers to the service. This third aspect of estimating income again builds on the estimation of the number of subscribers of the first aspect. Once again, to best understand the third method, a review of the mathematical underpinnings, as presented below, is helpful.

The subscribers to the service are segmented or divided such that the income behavior provided by each segment is constant. The total income provided by the subscribers is then a weighted aggregate (in terms of percentage of the total number of subscribers) of the segments. Therefore, although the average income provided by each segment is constant, the average contribution provided by the subscribers at a whole varies as the mix of the segments changes.

Assume there are N segments or divisions to the subscriber population. For each segment G, there is a constant average contribution provided by each subscriber C_{N}. Let i_{G}(t) denote the total income at time t for segment G, n_{G}(t) denote the number of subscribers at time t for segment G, and c_{G}(t) denote the average contribution by each subscriber in segment G. Since the average contribution by each subscriber c_{G}(t) in segment G is constant, c_{G}(t) can also be denoted as C_{G}. Further development of the equations from the first and second aspects provides
i_{G}(t)=C_{G}n(t−Δt)+C_{G}α′(t)−C_{G}s′(t)
i_{G}(t)=C_{G}[n_{G}(t−Δt)+α(t)−s′(t)]
i_{G}(t)=C_{G}[n_{G}(t)]
Said another way, the income at time t for a segment is the number of subscribers for that segment multiplied by the segment's subscribers average contribution.

The income function i(t) can be derived as the aggregate of the segments from the above equation. In this case, the weighting of each segment is the function of number of subscribers for that segment.

$$i ( t ) = {\sum }_{G = 1}^{N} {i}_{G} ( t ) = {\sum }_{G = 1}^{N} {C}_{G} {n}_{G} ( t )$$

The average contribution function can be developed as
c(t)=i(t)/n(t)
where

$$n ( t ) = {\sum }_{G = 1}^{N} {n}_{G} ( t ) .$$

The third method estimates the income, I_{T}, provided by subscribers to the service at the time period, T. The third method includes the step of dividing the subscribers into a plurality of subscriber groups.

An estimated rate of additions, A_{Rn}, to a number of subscribers, N_{Tn}, during each time period for each subscriber group is established. An estimated rate of departing subscribers, S_{Rn}, to the number of subscribers during each time period for each subscriber group is also established.

The third method further includes the step of calculating a number of subscribers, N_{Tn}, in each subscriber group based on the estimated rate of additions A_{Rn} and the estimated rate of departing subscribers, S_{Rn}.

An average contribution, Cₙ, attributable to each subscriber in each subscriber group is established. This average contribution, Cₙ, may be developed by reviewing historical data of wagering behavior for subscribers to the online gaming system.

The method continues with the step of calculating the total income, I_{T}, provided by subscribers at the time period, T, based on the number of subscribers, N_{Tn}, in each subscriber group and the average contribution, Cₙ, attributable to each subscriber in each subscriber group. The calculation of the total income, I_{T}, may be determined by calculating the group income, I_{Tn}, provided by subscribers at the time period, T, of each subscriber group based on the number of subscribers, N_{Tn}, and the average contribution, Cₙ, of each subscriber group and calculating the total income by summing the group incomes I_{Tn}.

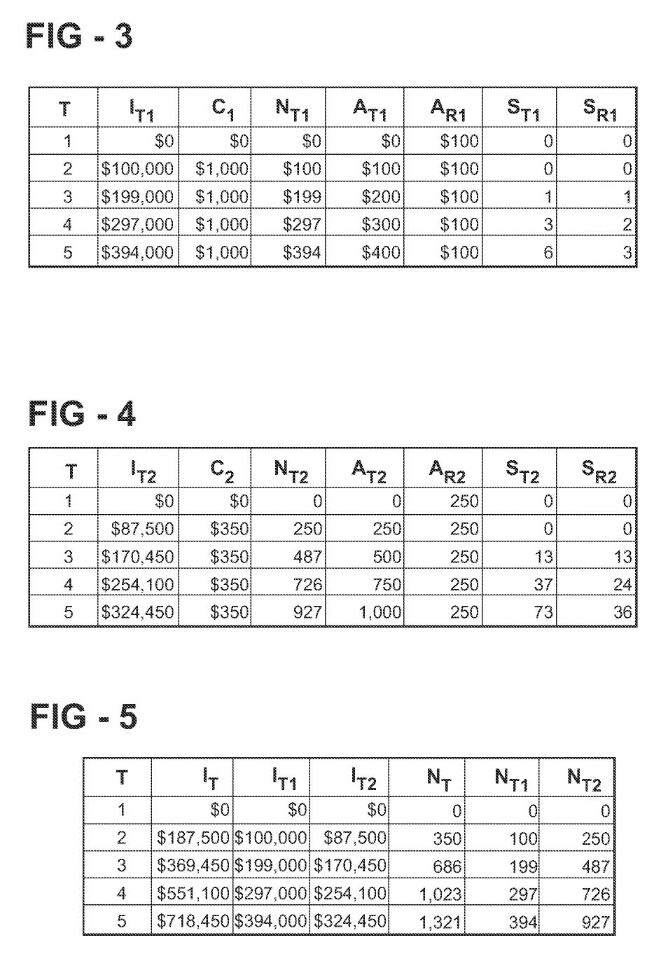

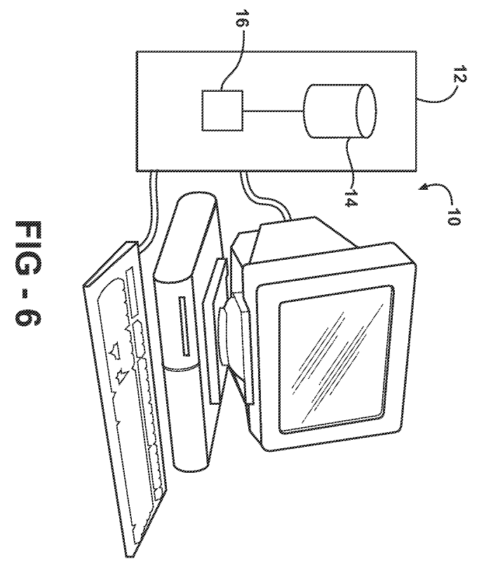

A third example showing performance of the third method is shown in FIGS. 3-5. In the third example, the number of subscribers is divided into two segments. FIG. 3 shows a first segment and FIG. 4 shows a second segment. In the first segment, the rate of additions, A_{R1}, is 100 new subscribers per time period and the rate of departures, S_{R1}, is 1% of the number of subscribers. The average contribution, C_{T1}, in the first segment is $1000. In the second segment, the rate of additions, A_{R2}, is 250 new subscribers per time period, the rate of departures, S_{R2}, is 5% of the number of subscribers, and the average contribution, C_{T2}, is $350.

Referring now to FIG. 5, the income provided by subscribers, I_{T}, during each time period, T, is simply the sum of the income provided by the income provided by subscribers I_{T1} in the first segment during each time period, T, and the income provided by subscribers, I_{T2}, in the second segment during each time period, T.

The subject invention also includes the computer based system 10 for estimating the number of subscribers to the service and/or the income provided by subscribers as described in the first, second, and/or third methods set forth above. In one embodiment, the computer based system is a calculating device, such as a personal computer (PC) 12. Suitable personal computers (PCs) 12 are well known to those in the art.

The computer based system 10 includes a memory 14 for storing data and a processor 16. The memory 14 may be random access memory (RAM), read-only memory (ROM), a hard drive, a CD-ROM, a floppy disk drive, a flash memory, a database, or other storage device known to those skilled in the art. The processor 16 is coupled to the memory 14. The processor 16, working in conjunction with the memory 14, calculates the number of subscribers to the service and/or the income provided by the subscribers as described in the methods.

In the one embodiment, the memory 14 and processor 16 are components of the PC 12. Those skilled in the art realize that the PC 12 may be running a computer program application suitable for performing repetitive and/or recursive calculations. Such applications include, but are not limited to, spreadsheets (such as Microsoft Excel) or databases (such as Microsoft Access).

Obviously, many modifications and variations of the present invention are possible in light of the above teachings. The invention may be practiced otherwise than as specifically described within the scope of the appended claims.

What is claimed is:

1. A method of estimating a number of subscribers (N_{T}) to a service at a time period (T), said method comprising the steps of:
calculating a cumulative number of additions (A_{T}) to the number of subscribers at the time period (T) based on a rate of additional subscribers (A_{R});
calculating a cumulative number of departures (S_{T}) to the number of subscribers at the time period (T) based on a rate of departing subscribers (S_{R}), the rate of departing subscribers (S_{R}) being a function of a preceding number of subscribers (N_{T-1}) at a preceding time period (T−1); and
calculating the number of subscribers (N_{T}) at the time period (T) based on an initial number of subscribers (N₀), the cumulative number of additions (A_{T}), and the cumulative number of departures (S_{T}).

2. A method as set forth in claim 1 wherein said step of calculating the cumulative number of additions (A_{T}) at the time period (T) is further defined as using the equation A_{T}=A_{T-1}+A_{R} where A_{T-1} is the cumulative number of additions to the number of subscribers at the preceding time period (T−1).

3. A method as set forth in claim 2 wherein the estimated rate of additions A_{R} is a constant value applicable to any time period.

4. A method as set forth in claim 3 further comprising the step of substituting a special number of additions (A_{S}) for the constant rate of additions (A_{R}) when calculating the cumulative number of additions (A_{T}).

5. A method as set forth in claim 1 wherein said step of calculating the cumulative number of departures (S_{T}) at the time period (T) is further defined as using the equation S_{T}=S_{T-1}+S_{R}P_{T-}1 where S_{T-1} is the cumulative number of departures to the number of subscribers at the preceding time period (T−1) and P_{T-1} is the number of subscribers at the preceding time period (T−1).

6. A method as set forth in claim 5 wherein the estimated rate of departing subscribers S_{R} is a constant value applicable to any time period.

7. A method as set forth in claim 1 further comprising the step of establishing the estimated rate of additions (A_{R}) according to an average rate of additions observed over a plurality of previous time periods.

8. A method as set forth in claim 1 further comprising the step of establishing the estimated rate of departing subscribers (S_{R}) according to an average rate of departures observed over a plurality of previous time periods.

9. A method of estimating an income (I_{T}) provided by subscribers to a service at a time period (T), said method comprising the steps of:
establishing a rate of additional subscribers (A_{R}) added during each time period;
establishing a rate of departing subscribers (S_{R}) departing during each time period;
calculating a preceding number of subscribers (N_{T-1}) at a preceding time period (T−1) which precedes the time period (T) based on an initial number of subscribers (N₀), the rate of new subscribers (A_{R}), and the rate of departing subscribers (S_{R});
establishing a first average amount of income (I_{A}) attributable to each added subscriber;
establishing a second average amount of income (I_{S}) lost for each departed subscriber;
calculating a preceding average contribution (C_{T-1}) to the income provided by each subscriber at the preceding time period (T−1) based on the first amount of income (I_{A}), the second amount of income (I_{S}), the estimated rate of additions A_{R}, the estimated rate of departures (S_{R}), and the preceding number of subscribers (N_{T-1}); and
calculating the income I_{T} provided by subscribers at the time period (T) based on the preceding average contribution (C_{T-1}), the preceding number of subscribers (N_{T-1}), the first amount of income (I_{A}), the second amount of income (I_{S}), the estimated rate of additions (A_{R}), and the estimated rate of departures (S_{R}).

10. A method as set forth in claim 9 further comprising the step of calculating a cumulative number of additions (A_{T}) to the number of subscribers at the time period (T) based on the estimated rate of additions (A_{R}).

11. A method as set forth in claim 10 further comprising the step of calculating a cumulative number of departures (S_{T}) to the number of subscribers at the time period (T) based on an estimated rate of departing subscribers (S_{R}) wherein the estimated rate of departing subscribers (S_{R}) is a function of the number of subscribers (N_{T-1}) at the preceding time period (T−1).

12. A method as set forth in claim 11 wherein said step of calculating the income (I_{T}) is further defined as using the equation I_{T}=C_{T-1}N_{T-1}+I_{A}A_{R}−I_{S}S_{R}.

13. A method of estimating an income I_{T} provided by subscribers to a service at a time period T, said method comprising the steps of:
dividing the subscribers into a plurality of subscriber groups;
establishing an estimated rate of additions A_{Rn} to a number of subscribers during each time period for each subscriber group;
establishing an estimated rate of departing subscribers S_{Rn} to the number of subscribers during each time period for each subscriber group;
calculating a number of subscribers N_{Tn} in each subscriber group based on the estimated rate of additions A_{Rn} and the estimated rate of departing subscribers S_{Rn};
establishing an average contribution Cₙ attributable to each subscriber in each subscriber group;
calculating the total income I_{T} provided by subscribers at the time period T based on the number of subscribers N_{Tn} in each subscriber group and the average contribution Cₙ attributable to each subscriber in each subscriber group.

14. A method as set forth in claim 13 wherein said step of calculating the total income I_{T} provided by subscribers at the timer period T is further defined as the steps of calculating the group income I_{Tn} provided by subscribers at the time period T of each subscriber group based on the number of subscribers N_{Tn} and the average contribution Cₙ of each subscriber group and calculating the total income by summing the group incomes I_{Tn}.

15. A method as set forth in claim 13 wherein the service is further defined as an online gaming system, the average contribution is further defined as an average wager made by each subscriber, and the total income is further defined as a handle.

16. A computer based system for estimating a number of subscribers (N_{T}) to a service at a time period (T), comprising:
a memory for storing data; and
a processor coupled to said memory for calculating a cumulative number of additions (A_{T}) to the number of subscribers at the time period (T) based on a rate of additional subscribers (A_{R}), calculating a cumulative number of departures (S_{T}) to the number of subscribers at the time period (T) based on a rate of departing subscribers (S_{R}), the rate of departing subscribers (S_{R}) being a function of a preceding number of subscribers (N_{T-1}) at a preceding time period (T−1), and calculating the number of subscribers (N_{T}) at the time period (T) based on an initial number of subscribers (N₀), the cumulative number of additions (A_{T}), and the cumulative number of departures (S_{T}).

17. A computer based system as set forth in claim 16 wherein said processor also for calculating an income (I_{T}) provided by subscribers at the time period (T).

18. A computer based system as set forth in claim 17 wherein the service is further defined as an online gaming system and the income is further defined as a handle.
